(19) United States
(12) Patent Application Publication
(10) Pub. No.: US 2014/0108089 A1
(43) Pub. Date: Apr. 17, 2014

(54) CYBERSPACE SECURITY SYSTEM FOR COMPLEX SYSTEMS

(71) Applicant: UT-Battelle, LLC, Oak Ridge, TN (US)

(72) Inventors: Robert K. Abercrombie, Oak Ridge, TN (US); Frederick T. Sheldon, Oak Ridge, TN (US); Ali Mili, Oak Ridge, TN (US)

(73) Assignee: UT-Battelle, LLC, Oak Ridge, TN (US)

(21) Appl. No.: 14/134,949

(22) Filed: Dec. 19, 2013

Related U.S. Application Data
(63) Continuation-in-part of application No. 13/443,702, filed on Apr. 10, 2012.
Application No. 13/443,702 is a continuation-in-part of application No. 12/421,933, filed on Apr. 10, 2009, now abandoned.
(60) Provisional application No. 61/748,235, filed on Jan. 2, 2013.
(60) Provisional application No. 61/052,556, filed on May 12, 2008.

(51) Int. Cl. G06Q 10/06

(52) U.S. Cl. CPC G06Q 10/0635
USPC 705/7.28

(57) ABSTRACT

A computer implemented method monetizes the security of a cyber-system in terms of losses each stakeholder may expect to lose if a security break down occurs. A non-transitory media stores instructions for generating a stake structure that includes costs that each stakeholder of a system would lose if the system failed to meet security requirements and generating a requirement structure that includes probabilities of failing requirements when computer components fails. The system generates a vulnerability model that includes probabilities of a component failing given threats materializing and generates a perpetrator model that includes probabilities of threats materializing. The system generates a dot product of the stakes structure, the requirement structure, the vulnerability model and the perpetrator model. The system can further be used to compare, contrast and evaluate alternative courses of actions best suited for the stakeholders and their requirements.

### PRIORITY CLAIM

This application claims the benefit of priority from U.S. Provisional Application No. 61/748,235 filed Jan. 2, 2013, under attorney docket number 2954.0, entitled “Cyberspace Security Econometrics Systems Enhancements for Evaluating Architectures,” which is incorporated herein by reference. This application is also continuation-in-part of U.S. Ser. No. 13/443,702 entitled “Cyberspace Security System” filed Apr. 4, 2012, which is a continuation-in-part of U.S. Ser. No. 12/421,933 entitled “System and Method for Implementing and Monitoring a Cyberspace Security Econometrics System and Other Complex Systems,” filed Apr. 10, 2009, which claims the benefit of priority under 35 U.S.C. §119(e) of U.S. Provisional Application No. 61/052,556, entitled “System and Method for Implementing and Monitoring a Cyberspace Security Econometrics System and Other Complex Systems,” filed on May 12, 2008, and is related to PCT/US09/42931 entitled “System and Method for Implementing and Monitoring a Cyberspace Security Econometrics System and Other Complex Systems,” filed May 6, 2009, each of which are incorporated by reference.

### STATEMENT REGARDING FEDERALLY SPONSORED RESEARCH AND DEVELOPMENT

The invention was made with United States government support under Contract No. DE-AC05-00OR22725 awarded by the United States Department of Energy. The United States government has certain rights in the invention.

### BACKGROUND

1. Technical Field

This disclosure relates to quantifying security, and particularly to risk-management systems that monetizes security vulnerabilities, component breakdowns, and security failures.

2. Related Art

Systems (both virtual and real [i.e., physical]) are often designed, operated, and maintained to survive cyber-attacks. The systems may maintain security by assessing risk and developing and implementing countermeasures that reduce or minimize attacks. Because cyber threats are often agile, multifaceted, well resourced, and persistent, protected systems must often modernize infrastructure in spite of limited resources.

To balance the cost of countermeasures against system performance, stakeholders need tools, cyber economic metrics, and incentives to allocate resources and adapt to changing threats. Quantifying the risk and the return on investment in cybernetics and other systems is challenging because there are few comprehensive systems that track the costs of security or predict loses caused by cyber-attacks and threats. Many analysts and architects lack an approach that allows them to monitor and quantify intrusions or model threats, vulnerabilities, security requirements, or stakes. Further, analysts and architects lack systems that monetize prospective losses caused by security failures.

### BRIEF DESCRIPTION OF THE DRAWINGS

FIG. 1 is a two dimensional stakes structure or stakes matrix of stakeholders versus requirements.

FIG. 2 is a two dimensional requirements structure or dependency matrix of requirements versus components.

FIG. 3 is a two dimensional vulnerability model or impact matrix of components versus threats.

FIG. 4 is a life cycle of key management.

### DETAILED DESCRIPTION OF THE PREFERRED EMBODIMENTS

A cyberspace security econometric (CSE) system monitors and improves security in near real-time. The CSE system identifies and measures properties associated with cyber threats, executes a measurable and repeatable quantitative algorithms that are independently verifiable by external sources. The CSE systems are inexpensive in terms of time and cost, may be audited for compliance and certification, and are scalable to individual systems off network and enterprises that scale across local and distributed networks. A CSE system may quantify failure impacts, interruptions, etc., as a function of cost per unit of time through metrics such as a Mean-Failure-Cost vector (MFC vector). An MFC vector may quantify and illustrate how much money one or more stakeholders may be expected to lose because of a security failure, a hardware failure, or a service interruption, for example.

Some CSE systems reflect variances that exist between different users or stakeholders. Different stakeholders may attach different stakes to the same requirement or service (e.g., a service may be provided by an information technology system, cyber or physical enterprise or process control system, etc.). For a given stakeholder, a CSE system may highlight variances that exist among the stakes attached to satisfying each requirement. For a given system specification such as a combination(s) of commercial off the shelf and customized software and/or hardware, CSE systems may identity variances amongst the levels of verification and validation that are performed on one or more components of the systems or the systems' specifications. The verification may render assurance scores in satisfying a specification or maintaining operation.

A MFC vector assigns to each system stakeholder a statistical mean of a random variable that represents the loss sustained by the stakeholder as a result of possible or expected security failures. This vector has one entry per stakeholder, and is quantified in terms of dollars per unit of time. The MFC vector may be expressed by Equation 1.

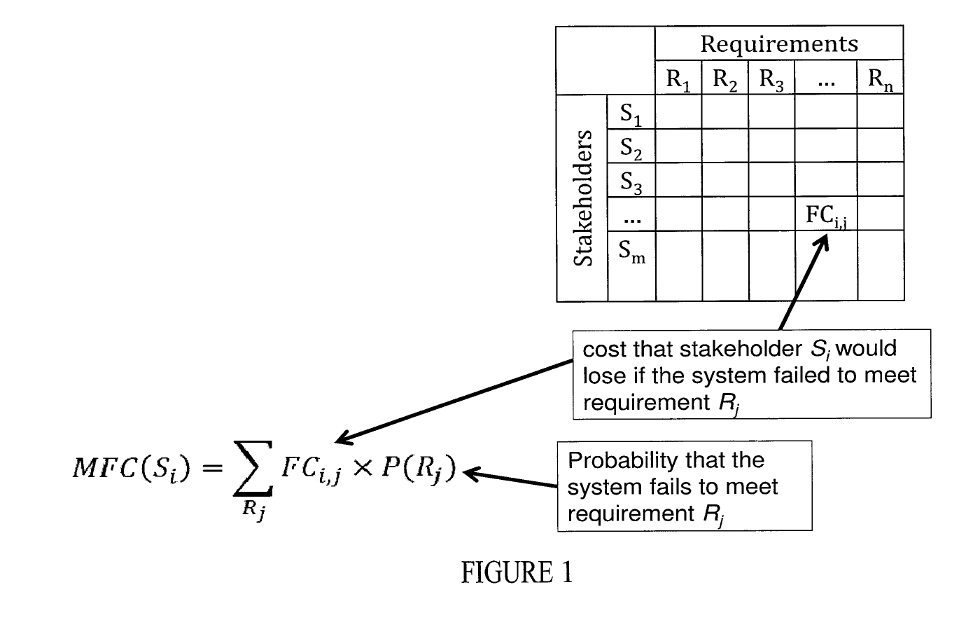

MFC=ST·PR, (1)

where ST is the stakes structure (or stakes matrix) and PR is the vector of requirement failure probabilities (one entry per requirement). The stakes structure reflects the stakes that each stakeholder has in meeting each identified security requirement along with expected monetary loss objects that each stakeholder bears for a failed security requirement. In FIG. 1, the stakes structure is modeled by a two dimensional matrix where the rows represent the stakeholders, the columns represent the analyzed system requirements, and the entries in the matrix represent the respective stakes. Some stakes structures also include a “no requirement failure” column that represents the cost associated when no security requirement fails.

The vector of requirement failure probabilities may be expressed by Equation 2:

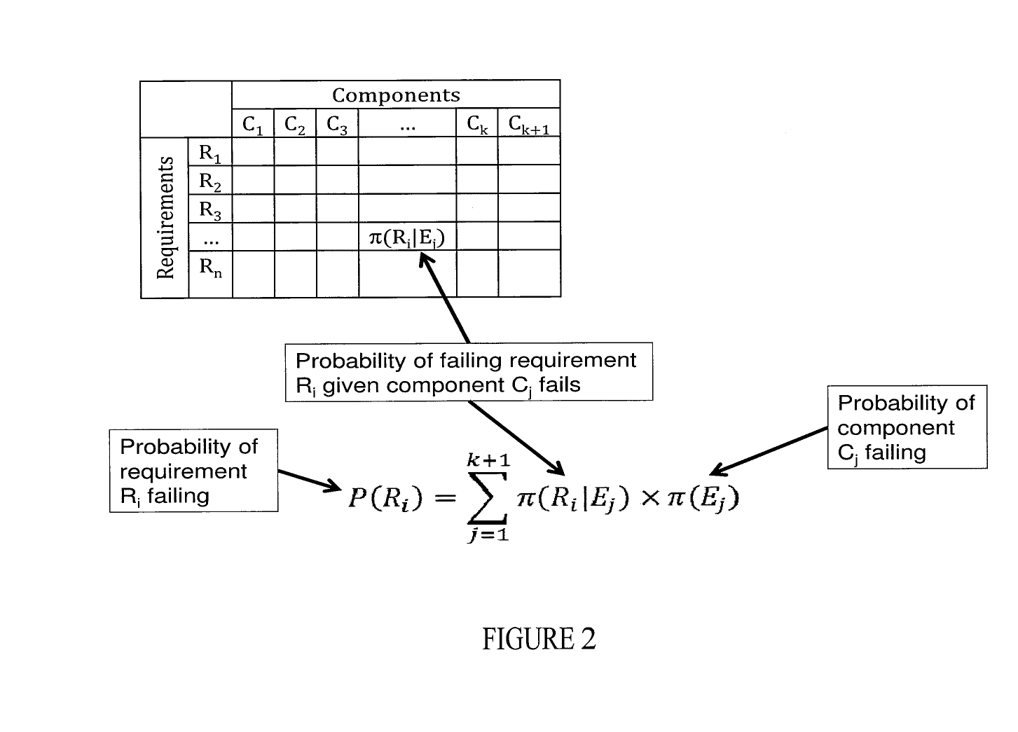

PR=DP·PE (2)

where DP models the requirement structure (or dependency matrix) and PE is the vector of component failure probabilities (one entry per component). The requirement structure may be derived by system architects or alternatively automatically through a knowledge base engine (e.g., the part of an expert system that contains the facts and rules), in light of the role that each component of the architecture plays to achieve each security goal. The requirements structure identifies the security requirements that are designated relevant or critical for each security requirement, and the role played by each component of the system architecture to meet each requirement. The DP model links the probability of failing a particular requirement with the probability of a component of the analyzed system. As such, the requirement structure may include a row designated “no requirement failure” where entries correspond to the likelihood an individual component fails results in no security requirement violations. In some systems, the model may be simplified when programmed by a rule that established that when security violation or threat occurs, it may affect no more than one component at a time. If Eᵢ, for 1≦i≦k, is the event, failure of component is Cᵢ, and at event Eₖ₊₁ no component has failed, the requirement structure may be modeled by a two dimensional matrix of the requirements versus components shown in FIG. 2.

The vector of components failure probabilities may be expressed by Equation 3:

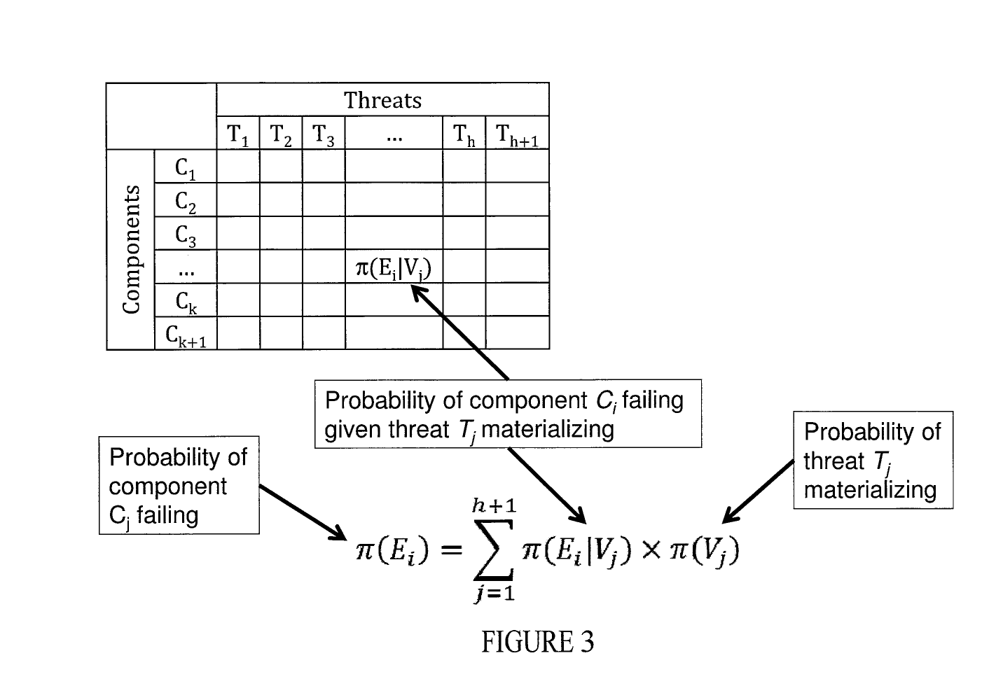

PE=IM·TV, (3)

where IM is the vulnerability model (or the impact matrix) and TV (TV=PV=PT can be used interchangeably) is the perpetrator model or vector of threat emergence probabilities (one entry by each type of threat). The vulnerability model may be derived by analysing and processing which threats affect which components, and assessing the likelihood of success of each threat, in light of natural events or un-natural events (e.g., perpetrator behavior) and the effect of possible countermeasures. The vulnerability model reflects to what extent each security threat targets each system component, and may be represented by a stochastic matrix that includes one column for each threat and one row for each component. The model identifies the vulnerabilities that arise from the architecture, and estimate to what extent each to threat of the perpetrator model targets each of the selected vulnerabilities. The vulnerability model may include a “no component failure row” that represents when a particular threat materializes but does not affect the associated component. And, it may include a “no threat column” that represents the cases when no threat materializes. To assess the likelihood of a particular threat leading to the failure of a component, the set of threats are expressed as T₁, T₂, . . . , Tₕ, the events are expressed as events V₁, V₂, . . . , Vₕ, Vₕ₊₁. When threat “i” materializes, Vᵢ, 1≦i≦h and when no threat i has materialized, Vₕ₊₁. If it the CSE system assumes that no more than one threat materializes at a time, the vulnerability model may be expressed by the exemplary two dimensional matrix shown in FIG. 3.

The perpetrator model or threat vector reflects the profile of common perpetrators and is represented by two or more security threats and their probability of occurrence per unit of operation time. The model may identify the perpetrators (natural or manmade), their expected outcomes, and how often (on average) they interfere with system operation. By simulating and/or operating the system and estimating the number of threats that have emerged, the perpetrator model is rendered by empirical measures.

To quantify failure impacts, interruptions, etc., as a function of cost per unit of time, the perpetrator model (e.g., the threat vector, TV), the vulnerability model (e.g., the impact matrix, IM), the requirements structure (e.g., the dependability matrix, DP), and the stakes structure (e.g., the stakes matrix, ST) may illustrate how much stakeholders may expect to lose because of a security failure, a hardware failure, a service interruption, etc., for example, by estimating the MFC vector that is expressed as Equation 4.

MFC=ST·DP·IM·TV, (4)

Equation 4 measures the risk that each stakeholder is taking with a security configuration, predicts the expected return for each stakeholder, and may estimate the insurance cost (e.g., project a prospective premium) for an insurance policy that may indemnify against loss.

The CSE system may evaluate any physical, virtual, or combined system (e.g., physical and virtual) such as an Advanced Metering Infrastructure (AMI). The stake structure (ST matrix) in an AMI system may be generated through a knowledge base engine according to the stakes the AMI stakeholders have in satisfying individual requirements. Thee requirement structure (DP matrix) may be generated through a cyber-operation or through a processor that determines how each AMI component contributes to meet each requirement. And the vulnerability model (IM matrix) may be generated through a cyber-operation or through a processor that determines how an AMI component is affected by each threat (e.g., through a classical failure modes and effects analysis). Empirical data may be processed by an expert system that may interface the knowledge base engine and an inference engine (e.g., the processing portion of the expert system, which matches the proposition with the facts and rules provided by the knowledge base engine) to form conclusions that render the perpetrator model (TV). The perpetrator model represents the probability of emergence of the various threats or vulnerabilities. Empirical validation of the values of perpetrator model may be measured by continually monitoring sensors that detect and measure the assets at risk, countermeasures and concomitant impacts if the assets are compromised.

Exemplary security requirements that may be imposed upon the AMI systems can be broken into three elements: confidentiality, integrity, and availability, in this example. Confidentiality ensures that only authorized parties are able to access cryptographic keys that secure data transmissions. A loss of confidentiality may result in unauthorized parties gaining access to any information that is protected by the key, including but not limited to personally identifiable information (PII) about a customer and customer energy usage data. Integrity ensures that the cryptographic keys are not altered by unauthorized parties. A failure of integrity may result in consequences such as power being shut off Availability ensures that cryptographic keys are available when needed. When availability is blocked, power may be shut off at the meter.

The stakeholders in one exemplary system may include a power utility, an AMI vendor, a Cryptographic Key Management System (CKMS) provider, a corporate customer, and a critical infrastructure customer (e.g. a hospital). To populate the stakes matrix (Table 1), the CSE system estimates how much money each stakeholder stands to lose when one of the security requirements was not met. The CSE system harvested data to estimate the stakes for each stakeholder and inferred potential losses for the hospital (e.g., critical infrastructure customer).

TABLE 1
Stakes Matrix: Stakeholders vs. Requirements

| | | Requirements | | | |
|---|---|---|---|---|---|
| | | | | | No |
| | | | | | Require- |
| | | Confiden- | | | ment |
| Stakes (ST) | | tiality | Integrity | Availability | Failure |
| Stake- | Utility | $762,044 | $10,000 | $10,000 | $0 |
| holders | AMI Vendor | $762,044 | $100,000 | $5,000 | $0 |
| | CKMS | $762,044 | $100,000 | $200,000 | $0 |
| | Provider | | | | |
| | Corporate | $31,140 | $1,363 | $1,363 | $0 |
| | Customer | | | | |
| | Critical | $311,400 | $13,630 | $13,630 | $0 |
| | Infrastructure | | | | |
| | Customer | | | | |

In Table 1, the “no requirement failure” (NRF) column represents the cost associated when no requirement fails. It is monetized as no cost, because if there is no failure there is no loss.

The requirement structure (DP matrix shown as Table 3) assesses the architecture of the system in light of the role that each of the recited components plays to achieve each security requirement. Whether a particular security requirement is met may depend on which component of the system architecture is operational. In highly complex systems these operational components may be rolled up in a hierarchical analysis that may simplify the computations. The exemplary requirement structures may be harvested from the National Institute Standards and Technology (NIST) Interagency Report (NISTIR). Specifically categories 13-18 summarized in Table 2 relevant to AMI systems were mined from the NISTIR 7628.

TABLE 2
Advanced Metering Infrastructure related interfaces
Component Details

| Category | Description - Interfaces between . . . |
|---|---|
| 13 | Systems that use the AMI network |
| 14 | Systems that use the AMI network for functions |
| | that require high availability |
| 15 | Systems that use customer site networks |
| 16 | External systems and the customer site |
| 17 | Systems and mobile field crew equipment |
| 18 | Metering equipment |

In Table 3, “C” represents confidentiality, “I” represents integrity, “A” represents availability and the “no requirement failure” row (NRF) represents the case when a component fails, but does not affect the associated requirement. In Table 3 NCF column represents the case when no component fails.

TABLE 3
Dependency Matrix

| | | Components | | | | | | |
|---|---|---|---|---|---|---|---|---|
| | | (Smart Grid Architecture AMI Logical | | | | | | |
| | | Interface Categories from NISTIR 7628) | | | | | | |
| | | | | | | | | No |
| Dependency | | | | | | | | Component |
| (DP) | | 13 | 14 | 15 | 16 | 17 | 18 | Failure (NCF) |
| Requirements | C | .3 | .3 | .1 | .3 | .1 | .1 | 0 |
| | I | .3 | .3 | .2 | .2 | .3 | .3 | 0 |
| | A | .1 | .3 | .2 | .1 | .2 | .1 | 0 |
| | NRF | .3 | .1 | .5 | .4 | .4 | .5 | 1 |

In table 3, the entries that comprise the columns were normalized and sum to one. The probability of failing requirements “Confidentiality”, “Integrity”, and “Availability” given a component “13”, “14”, “15”, “16”, “17”, and “18” is ranked at 30% at the highest, 20% at the median, and 10% at the low end.

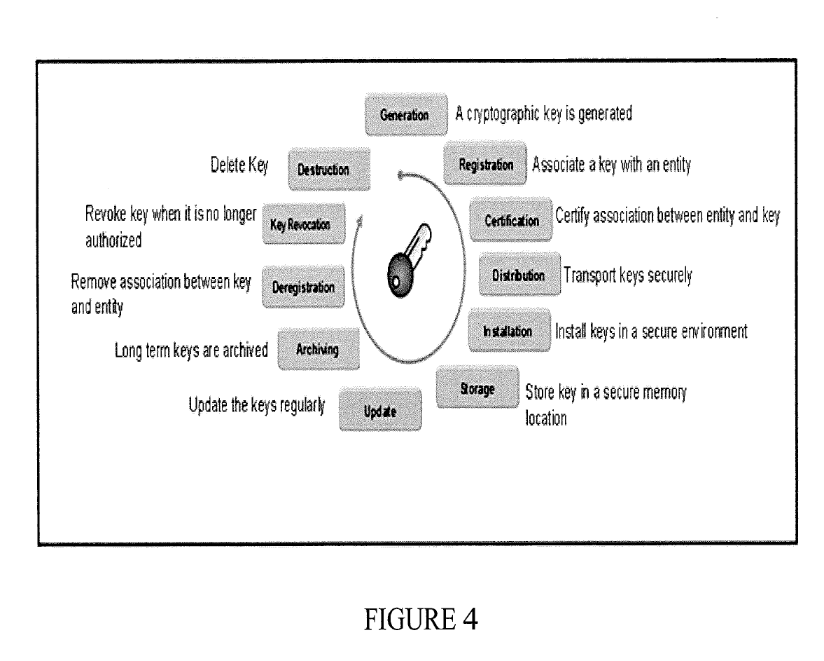

To determine the threats against the AMI system, the CSE system harvested Part 9 of the International Electrotechnical Commission (IEC) 62351 data which specifies how to generate, distribute, revoke and handle digital certificates and cryptographic keys that protect digital data and communication. Visually, the vulnerability model (IP matrix) enumerate the life cycle of key management shown in FIG. 4 into threats categories (Tx) comprising: T1 Generation, T2 Registration, T3 Certification, T4 Distribution, T5 Installation, T6 Storage, T7 Derivation, T8 Update, T9 Archiving, T10 Deregistration, T11 Key Revocation, T12 Destruction, and T13 No Threat.

From these divisions, the CSE system generates the threat categories

TABLE 4
Impact Matrix

| | | Threats | | | | | | | | | | | | |
|---|---|---|---|---|---|---|---|---|---|---|---|---|---|---|
| Impact | | | | | | | | | | | | | | No |
| (IM) | | T1 | T2 | T3 | T4 | T5 | T6 | T7 | T8 | T9 | T10 | T11 | T12 | Threat |
| Compo- | 13 | .21 | .10 | .14 | .14 | .14 | .14 | .14 | .14 | .14 | .14 | .14 | .14 | 0 |
| nents | 14 | .02 | .26 | .14 | .14 | .14 | .14 | .14 | .14 | .14 | .14 | .14 | .14 | 0 |
| | 15 | .01 | .08 | .14 | .14 | .14 | .14 | .14 | .14 | .14 | .14 | .14 | .14 | 0 |
| | 16 | .02 | .26 | .14 | .14 | .14 | .14 | .14 | .14 | .14 | .14 | .14 | .14 | 0 |
| | 17 | .05 | .09 | .14 | .14 | .14 | .14 | .14 | .14 | .14 | .14 | .14 | .14 | 0 |
| | 18 | .35 | .10 | .14 | .14 | .14 | .14 | .14 | .14 | .14 | .14 | .14 | .14 | 0 |
| | NCF | .35 | .10 | .16 | .16 | .16 | .16 | .16 | .16 | .16 | .16 | .16 | .16 | 1 |

detailed in Table 4. The vulnerability model (e.g., the IM Matrix) reads like the requirement structure (e.g., the DP Matrix). Looking at the entry in which threat T1 materializes and assuming threat T1 may cause no more than one component to fail, there is a probability of 0.21 (21%) that the component that fails will be component 13.

The perpetrator model (or probability threat (PT) vector, [TV=PV=PT]) identifies the perpetrators and how often (on average) the perpetrators interfere with system operation. This information may be harvested from empirical measurements. Since electronic key management in this example is a mature technology, the threats against the lifecycles among the twelve threat categories are listed in Table 5.

TABLE 5
Probability Threat Vector

| | | Probability of threat |
|---|---|---|
| Threat Vector (PT) | | materializing per day |
| Threats | T1 Generation | 0.02 |
| | T2 Registration | 0.10 |
| | T3 Certification | 0.05 |
| | T4 Distribution | 0.05 |
| | T5 Installation | 0.05 |
| | T6 Storage | 0.05 |
| | T7 Derivation | 0.04 |
| | T8 Update | 0.04 |
| | T9 Archiving | 0.04 |
| | T10 Deregistration | 0.03 |
| | T11 Key Revocation | 0.04 |
| | T12 Destruction | 0.02 |
| | T13 No Threat | 0.47 |

The MFC vector may be calculated using Equation 4 to render the MFC vector shown in Table 6. Table 6 shows the individual Stakeholder's Mean Failure Cost in units of

TABLE 6
Stakeholder Mean Failure Cost

| Mean Failure Cost | | Cost per day |
|---|---|---|
| Stakeholders | Utility | $83,689 |
| | AMI Vendor | $94,272 |
| | CKMS Provider | $106,479 |
| | Corporate Customer | $3,595 |
| | Critical Infrastructure Customer | $35,950 |

currency per time frame, e.g. dollars per day. The MFC vector gives stakeholders a sense of how much money they will lose, on average, if a threat materializes. Stakeholders may use the MFC to determine which security measures are worth implementing in their system and which are more expensive to implement than what the stakeholder stands to lose on average.

The CSE system may also assess the smart grid based on risk assessment approaches developed by other sources including both the private and public sectors. These systems identify assets, vulnerabilities, and threats and specify potential impacts to produce an assessment of risk to the smart grid and to stakeholders and assets that make up the domains and subdomains, such as homes and businesses. Because the smart grid includes systems from the IT, telecommunications, and power system technology domains, the risk assessment process may applied to the three domains.

In another example, the CSE system may rank a threat candidate through a contextual semantic assessment. Contextual semantics refers to the types of semantic information that may be inferred about words, objects, or concepts by the contexts the concepts appear in, for example. A contextual semantics assessment engine may assess and in some instances automatically rate the meaning of a threat because threats or vulnerabilities that appear in the same context may share common contextual features. For example, a contextual assessment may weigh when a threat candidate develops or occurs. In a power distribution system, for example, a denial of service at a generator may result in a more significant threat (and therefore, may have a more significant effect) than if the denial of service occurred at single to point of distribution (e.g., smart meter), because it may affect a larger population. A contextual sematic assessment would identify the denial of service and assess its effect

Threat candidates may also be assessed through threat (e.g., failure) scenario (use of modeling to identify relevant threats or vulnerabilities) enumeration engines and predetermined criteria established by the defenders (e.g., the stakeholders) and known threat candidates. Historical records of known threats or vulnerabilities may also be used to identify the likelihood of a threat emerging just as factors that affect a machine's performance and lifetime. This may be shown by an assessment engine's recognition that while each threat may be different, some share common features and manifestations when the threat materializes.

Using the CSE system, the ST matrix is generated according to the predetermined stakes the stakeholders have in satisfying individual requirements; the DP matrix is generated according to how each component contributes to meet each requirement; the IM matrix is generated according to how each component is affected by each threat. Empirical data is processed to generate the vector of threat emergence probabilities (PV) that represents the probability of emergence of the various threats or vulnerabilities that are under consideration.

The monetary loss each stakeholders stands to lose upon violation of a given security requirement is documented as follows and is presented in the stakes matrix shown as Table 7.

TABLE 7
ST Matrix: Stakeholders vs. Requirements

| | | Requirements | | | |
|---|---|---|---|---|---|
| | | | | | No Req’t. Failure |
| Stakes (ST) | | Confidentiality | Integrity | Availability | (NRF) |
| Stake- | Utility | $762,044 | $10,000 | $10,000 | $0 |
| holders | AMI Vendor | $762,044 | $100,000 | $5,000 | $0 |
| | CKMS | $762,044 | $100,000 | $200,000 | $0 |
| | Provider | | | | |
| | Corporate | $31,140 | $1,363 | $1,363 | $0 |
| | Customer | | | | |
| | Critical | $631 | $3.82 | $3.82 | $0 |
| | Residential | | | | |
| | Customer | | | | |

Note:
The NRF column represents the cost associated when no requirement fails and is provided for completeness (to explicitly denote this case).

Using documented interfaces from the NISTIR 7628, a public power utility, AMI vendor, CKMS provider, corporate customer, and residential customer may be evaluated under categories 13-18 relevant to AMI from the NISTIR 7628 data categorized in Table 8.

TABLE 8
Advanced Metering Infrastructure related interfaces
Component Details

| Category | Description - Interfaces between . . . |
|---|---|
| 13 | Systems that use the AMI network |
| 14 | Systems that use the AMI network for |
| | functions that require high availability |
| 15 | Systems that use customer site networks |
| 16 | External systems and the customer site |
| 17 | Systems and mobile field crew equipment |
| 18 | Metering equipment |

The DP matrix shown in Table 9 assesses the architecture of the system in light of the role that each of the recited components of the architecture plays to achieve each security requirement. Whether a particular requirement is met depends on which component of the system architecture is operational. In Table 8, the qualitative ratings from NISTIR 7628 data of High, Medium and Low were normalized to the numeric equivalent of 0.3, 0.2 and 0.1 respectively as explained in the prior embodiment.

TABLE 9
Dependency Matrix

| | | Components | | | | | | |
|---|---|---|---|---|---|---|---|---|
| | | (Smart Grid Architecture AMI Logical | | | | | | |
| | | Interface Categories from NISTIR 7628) | | | | | | |
| | | | | | | | | No |
| Dependency | | | | | | | | Component |
| (DP) | | 13 | 14 | 15 | 16 | 17 | 18 | Failure (NCF) |
| Requirements | C | .3 | .3 | .1 | .3 | .1 | .1 | 0 |
| | I | .3 | .3 | .2 | .2 | .3 | .3 | 0 |
| | A | .1 | .3 | .2 | .1 | .2 | .1 | 0 |
| | NRF | .3 | .1 | .5 | .4 | .4 | .5 | 1 |

Note:
the NRF row represents the case when a component fails but does not affect the associated requirement. The NCF column represents the case when no component fails.

In determining the threats against the AMI system, National Electric Sector Cyber security Organization Resource (NESCOR) data was mined to validate the threats. The three threats harvested and evaluated are shown in Table 10.

TABLE 10
Threat Description Details

| | |
|---|---|
| AMI-1 | Wide use of same symmetric key |
| AMI-2 | Creation of duplicate Access Point Name |
| | (APN) |
| AMI-3 | Time-stamping falls out of sync |

In this example, the CSE system groups the threats aside from the three above into the category ‘Other Threats,’ which were processed like a specific threat when generating the IM Matrix. Threat 1 stems from failure scenarios AMI.4 and AMI.5, threat 2 stems from AMI.17, and threat 3 stems from AML 19 in the NESCOR data.

TABLE 11
Impact Matrix

| | | Threats | | | | |
|---|---|---|---|---|---|---|
| Impact | | AMI- | AMI- | AMI- | Other | No |
| (IM) | | 1 | 2 | 3 | Threats | Threat |
| Compo- | 13 | 0 | .3 | .5 | .1 | 0 |
| nents | 14 | .2 | .3 | .2 | .1 | 0 |
| | 15 | 0 | 0 | 0 | .1 | 0 |
| | 16 | 0 | .2 | .1 | .1 | 0 |
| | 17 | 0 | .1 | 0 | .1 | 0 |
| | 18 | .6 | .1 | .1 | .1 | 0 |
| | NCF | .2 | 0 | .1 | .4 | 1 |

Note:
the NCF row represents the case when a threat materializes but does not affect the associated component. The No Threat column represents the case when no threat materializes.

Using the details of the NESCOR failure scenarios and the NISTIR interface categories, the CSK system shows how the three threats could affect the infrastructure. The IM matrix (Table 11) specifies the threats or vulnerabilities that may have been experienced. In this example, it comprises a subset of the threats or vulnerabilities. Table 11 also illustrates the probability of emergence of a subset of threats during operation. In this example, the IM matrix represents a fault model that catalogs the threats or vulnerabilities that the AMI faces.

The TV (or threat vector (PV) of Table 12) identifies the perpetrators and how often (on average) the perpetrators interfere with system operation.

TABLE 12
Probability Threat Vector

| | | Probability of threat |
|---|---|---|
| Threat Vector (PV) | | materializing during a day |
| Threats | AMI-1 | 0.005 |
| | AMI-2 | 0.005 |
| | AMI-3 | 0.03 |
| | Other Threats | 0.16 |
| | No Threats | 0.8 |

The MFC vector is calculated by Equation 4 to render the MFC vector shown in Table 13.

TABLE 13
Stakeholder Mean Failure Cost (MFC)

| Mean Failure Cost | | Cost per day |
|---|---|---|
| Stakeholders | Utility | $22,368 |
| | AMI Vendor | $25,501 |
| | CKMS Provider | $29,664 |
| | Corporate Customer | $969 |
| | Residential Customer | $18.27 |

In Table 13, the MFC is in units of currency per time frame, e.g. dollars per day. Stakeholders may use the MFC to determine which security measures are worth implementing in their system and which are more expensive to implement than what the stakeholder stands to gain (by reducing his loss by means of the security measure).

Stakeholders may also use the CSE systems to compare systems such as alternative encryption mechanisms/systems (E1 and E2) and/or alternative architectures. When alternative encryption systems are compared, separate vulnerability models (e.g., two or more impact matrices may be generated) are rendered IM1 and IM2. If ΔIM is defined as the difference (IM1−IM2) the CSE system may derive the difference in risk as measured in the MFC vector as expressed in Equation 5

ΔMFC=ST·DP·ΔIM·TV (5)

Because MFC is a vector, rather than a scalar, it establishes a partial ordering rather than a total ordering between the options E1 and E2.

Stakeholders may also use CSE to compare alternative architectures (e.g., A1 and A2). For A1 and A2, DP1 and DP2 (e.g., two or more dependency matrices) correspond to these architectures. If ΔDP is the difference (DP1−DP2) the difference in risk measured by the MFC vector may be expressed in Equation 6.

ΔMFC=ST·ΔDP·IM·TV (6)

Stakeholder systems may process the MFC vector rendered by the CSE systems to determine if an investment in an enhanced security will provide a return for a given stakeholder “h”. In these systems, the systems define IC(h) as the contribution of stakeholder “h” to the overall IC, and ΔMFC(h) as the MFC reduction that results from the enhanced security, prorated to a year. The systems compute a return on investment for stakeholder “h” based on Equation 7, using “Y” for the length of the investment cycle, and “d” for the discount rate:

$$ROI ( h ) = \frac{1}{IC ( h )} \times {\sum }_{y = 1}^{Y} \frac{Δ MFC ( h )}{{( 1 + d )}^{y}} - 1 \qquad ( 7 )$$

In Equation 7, ROI(h) represents the return on investment of stakeholder “h” that results from the security enhancement at hand, given that he contributed IC(h) to the cost of this enhancement, and this enhancement has reduced his yearly mean failure cost by MFC(h).

The MFC vector may also be further processed to determine how to distribute the cost of investment cost (IC) among stakeholders if it is assumed that all stakeholders must have the same ROI. For H stakeholders, this principle generates (H-1) equations, which when added to the equation that the sum of all IC(h) equals IC determines for all the stakeholder investment costs. If stakeholders do not have the same ROI, the system may be configured to optimize the return on investment for privileged stakeholders, say “h0. ” The system may be configured to maximize the ROI for “h0” provided there is more than one stakeholder and the stakeholders are not identical.

Other CSE systems and applications may also be formed from combinations of structure and functions described or illustrated and used in other applications. In an insurance application, for example, the ST matrix identifies the cost (e.g., in US Dollars) of how much the stakeholder stands to lose if the requirement (e.g., confidentiality, integrity and availability) is violated. In insurance terms, if someone is insuring their home, ST contains the value of their home (or the damage caused to their home by a hurricane, a flood, and earthquake and a fire) and MFC contains the yearly premium for their home insurance (according to the likelihood of each one of these calamities in a given year). The DP matrix represents how the insurance requirements are dependent upon the proper operation of individual components of the overall insured system. The IM matrix relates component failures to threats. It represents the probability of failure of components given that a specific threat has materialized.

The methods, devices, systems, and logic that control the operation of the CSE system may be implemented in or may be interfaced in many other ways in many different combinations of hardware, software or both and may be applied to different applications. All or parts of the system may be executed through one or more programs executed by controllers, one or more microprocessors (CPUs), one or more signal processors (SPU), one or more application specific integrated circuit (ASIC), one or more programmable media or combinations of such hardware. All or part of the systems may be implemented as instructions or programs stored on a non-transitory medium (e.g., a machine readable medium) or memory executed by a CPU/SPU/ASIC that comprises electronics including input/output interfaces, application program interfaces, and an up-dateable memory comprising at least a random access memory and/or flash memory which is capable of being updated via an electronic medium and which is capable of storing updated information, processors (e.g., CPUs, SPUs, and/or ASICs) controller, an integrated circuit that includes a microcontroller or other processing devices that may execute software stored on a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, includes a specifically programmed non-transitory storage medium and computer readable instructions stored on that medium, which when executed, cause the control system to perform the specially programmed operations.

The term “coupled” disclosed in this description may encompass both direct and indirect coupling. Thus, first and second parts are said to be coupled together when they directly communicate with one another, as well as when the first part couples to an intermediate part which couples either directly or via one or more additional intermediate parts to the second part. The term “analyst” encompasses an expert system that performs or executes an analysis. The term “substantially” or “about” may encompass a range that is largely, but not necessarily wholly, that which is specified. It encompasses all but a significant amount. When modules or components of the CSE systems are responsive to events, the actions and/or steps of devices, such as the operations that other devices are performing, necessarily occur as a direct or indirect result of the preceding events and/or actions. In other words, the operations occur as a result of the preceding operations. A device that is responsive to another requires more than an action (i.e., the device's response to) merely follow another action. When CSE systems operate in real-time, the operation may match a human's perception of time or a virtual process that is processed at the same rate (or perceived to be at the same rate) as a physical or an external process (e.g., such at the same rate as the monitored system). The physical or external process is defined by the computing session in which data is received and/or processed or during the time in which a program is running that begins when the data is received.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A computer implemented method of estimating the security of a cyber-system in terms of loss each stakeholder stands to lose as a result of a security breakdown, comprising programming stored on a non-transitory medium for:
generating a stake structure that comprises a plurality of costs that each of a plurality of stakeholders of a system would lose if the system failed to meet a plurality of security requirements;
generating a requirement structure that comprises a plurality of probabilities of failing the plurality of security requirements when a plurality of computer components fails;
generating a vulnerability model that comprises a plurality of probabilities of a component failing given a plurality of threats materializing;
generating a perpetrator model that comprises a plurality of probabilities of threats materializing; and
generating a dot product of the stakes structure, the requirement structure, the vulnerability model and the perpetrator model.

2. The computer implemented method of claim 1 further comprising generating a mean failure cost vector.

3. The computer implemented method of claim 2 where the mean failure cost vector comprises a cost each stakeholder will lose if one of the plurality of threats materializes.

4. The computer implemented method of claim 1 where some of the plurality of threats is directed to computer hardware and some of the plurality of threats is directed to software stored on a non-transitory media.

5. The computer implemented method of claim 1 where the stakes structure comprises a stakes matrix of the plurality of stakeholders versus the plurality of requirements, where the entries of the stake matrix comprise a plurality of stake objects.

6. The computer implemented method of claim 5 where the stakes matrix comprises a column that represents cost associated with none of the plurality of security requirements failing.

7. The computer implemented method of claim 1 where the requirement structure comprises a dependency matrix of the plurality of security requirements versus a plurality of computer components, where the entries of the dependency matrix comprise the probability of failing one of the plurality of security requirements given a failure of one of the plurality of computer components.

8. The computer implemented method of claim 7 where the dependency matrix comprises a row that represents one of the plurality of computer components fails without affecting any of the plurality of security requirements.

9. The computer implemented method of claim 7 where the dependency matrix comprises a column that represents none of the computer components failing.

10. The computer implemented method of claim 1 where the vulnerability model comprises an impact matrix of a plurality of computer component failures versus a plurality of threats materializing, where the entries of the impact matrix comprise the probability of failing one of the plurality of computer components given of the plurality of threats materializing.

11. The computer implemented method of claim 10 where the impact matrix comprises a row that represents one of the plurality of threats materializing without affecting any of the plurality of computer components.

12. The computer implemented method of claim 9 where the impact matrix comprises a column that represents none of the plurality of threats materializing.

13. A method of estimating the security of a cyber-system in terms of loss each stakeholder stands to sustain as a result of a security breakdown, comprising:
generating a stake structure that comprises a plurality of costs that each of a plurality of stakeholder of a system would lose if the system failed to meet a plurality of security requirements;
generating a requirement structure that comprises a plurality of probabilities of failing the plurality of security requirements when a plurality of computer components fails;
generating a vulnerability model that determines a plurality of probabilities of a component failing given a plurality of threats materializing;
generating a perpetrator model through an expert system that renders a plurality of probabilities of threats materializing; and
processing the stakes structure, requirement structure, vulnerability model and the perpetrator model to render an estimate of a loss.

14. The method of claim 13 further comprising generating a mean failure cost vector.

15. The method of claim 13 where the mean failure cost vector comprises a cost each stakeholder will lose if one of the plurality of threats materializes.

16. The method of claim 13 where some of the plurality of threats is directed to computer hardware and some of the plurality of threats is directed to software stored on a non-transitory media.

17. The method of claim 13 where the stakes structure comprises a stakes matrix of the plurality of stakeholders versus the plurality of security requirements, where the entries of the stake matrix comprise a plurality of stake objects.

18. The computer implemented method of claim 13 where the requirement structure comprises a dependency matrix of the plurality of requirements versus a plurality of computer components, where the entries of the dependency matrix comprise the probability of failing one of the plurality of security requirements given a failure of one of the plurality of computer components.

19. The method of claim 13 where the vulnerability model comprises an impact matrix of a plurality of computer component failures versus a plurality of threats materializing, where the entries of the impact matrix comprise the probability of failing one of the plurality of computer components given of the plurality of threats materializing.

20. The method of claim 13 where the structure comprises a difference between a plurality of dependency matrices.

21. The method of claim 20 where the vulnerability model comprises a difference between a plurality of impact matrices.

22. The method of claim 13 where the vulnerability model comprises a difference between a plurality of impact matrices.

23. An econometrics-based control system comprising:
a processor;
a memory in communication with the processor, the memory configured to store processor implementable instructions, where the processor implementable instructions are programmed to:
generate a stakes matrix that reflects the cost of having one or more system requirements fail for at least one stakeholder, said stakes matrix having a column for no requirement failure;
generate a dependency matrix that links a status of at least one component with each of the one or more system requirements, said dependency matrix having a column for no requirement failure;
generate an impact matrix to link a possible threat with each of the at least one component, said impact matrix having a column for no threat;
generate a probability threat vector to link the probabilities of each threat materializing within a specified time frame;
determine a mean failure cost as a function of the stakes matrix, the dependency matrix, the impact matrix, and the probability threat vector;
analyze the mean failure cost to determine a control strategy; and
a communication component in communication with the processor and the memory, the communication component configured to communicate the control strategy to a controller component operable within the control system, where the controller component implements the control strategy.
